(19) United States
(12) Patent Application Publication
(10) Pub. No.: US 2004/0037918 A1
(43) Pub. Date: Feb. 26, 2004

(54) Extruded bird food product

(76) Inventor: Martin Glinsky, (US)

Correspondence Address: GREENBERG TRAURIG, LLP, 885 3RD AVENUE, NEW YORK, NY, 10022, US

(21) Appl. No.: 10/461,794

(22) Filed: Jun. 13, 2003

Related U.S. Application Data
(60) Provisional application No. 60/404,841, filed on Aug. 21, 2002.

(51) Int. Cl. A01K 1/00

(52) U.S. Cl. 426/2

(57) ABSTRACT

An extruded bird food product made from a mixture containing grains, seeds, nuts and fresh fruits and vegetables.

### FIELD OF THE INVENTION

The present invention relates to a bird food product which is made by extruding a mixture containing grains, seeds and nuts as well as fresh fruit and fresh vegetables.

### BACKGROUND OF THE INVENTION

Veterinarians and animal nutritionists have recognized that the majority of sick bird cases are due to inadequate or poor dietary habits. Improper nutrition can result from both undernutrition and overnutrition. In the wild, birds eat a varied diet including fruits, vegetables, sprouts, soil, mineral deposits, meats and fish. Birds possess an innate knowledge of how to select the appropriate food sources available in the wild to ensure a balanced diet. Domesticated birds, however, do not have the luxury of choosing from a variety of natural dietary foodstuffs. In the past, it was not unusual to feed birds a diet consisting solely of seeds. A balanced pet bird diet must contain a combination of the necessary nutrients to meet the nutritional requirements of the bird. Many commercial bird foods claim to provide a nutritionally complete bird diet. Conventional extruded food is vitamin enriched and contains nutrition made up of grains. Common seed blends contain seeds, nuts, dried fruits and vegetables, grains and are also vitamin enriched. Typically, these commercially available diets require further supplementation.

### DESCRIPTION OF PRIOR ART

Extruded pet food products are well known in the art, particularly for dogs and cats. By way of example, reference is made to U.S. Pat. Nos. 4,041,181; 4,225,630; 4,310,558, 6,410,079. The components are combined and then fed into an extruder where they are mixed, heated/cooked and expanded. The extrudate is then emitted from the extruder and cut.

Historically, caged birds were fed diets consisting mainly of seeds and nuts. The seed diet is insufficient to maintain optimal health. Seed and nut blends are high in fat and lack many important vitamins, minerals and amino acids, which can lead to obesity, a depressed immune response system and other nutrient deficient diseases. Seeds are very low in calcium and deficient in the amount and quality of protein. Fortified “premium” seed blends have attempted to correct the nutritional limitations of seed blends by adding dried fruits and vegetables as well as vitamins and minerals. A pellet containing added nutrients is often added to the seed mixture in an attempt to provide adequate nutrition.

Current pelleted diets attempt to provided complete nutrition by a basic combination of cereal grains and vitamin/mineral supplementation. These blends exhibit decreased palatability and stimulate a low level of interest for pet birds. In many commercial preparations, the pellets are not consumed because the bird does not recognize them as food, does not find their shapes to be interesting, or does not find the taste appealing. Some conventional bird foods offer a variety of seeds and fortified pellets. These blends can lead to “selective feeding,” picking and choosing which items to eat and which discard, and improper nutrition results as birds are able to choose their favorite foods within the blend.

### SUMMARY OF THE INVENTION

It is an object of this invention to provide an extruded bird food product containing a combination of seeds, extruded pellets, fresh fruits and vegetables for complete, balanced nutrition.

The object of the invention is to produce an extruded diet that is a nutritionally-balanced, highly palatable food blend containing nutrients from all the necessary food groups and the proper combinations of proteins, fats, carbohydrates and micro-nutrients (vitamins and minerals) to maintain optimal avian health.

The present invention comprises an extruded avian diet made up of fresh fruits and vegetables, seeds, nuts, grains, dried fruits and vegetables, and vitamin enriched for total avian nutrition. This food is a unique slurry of wholesome, choice ingredients including fresh fruits, fresh vegetables, select seeds, crunchy nuts, wholesome grains, and essential proteins, that is fortified with important vitamins and minerals and also contains probiotics for a healthy selection of intestinal bacteria. The extruded diet can optionally be multi-colored, multi-shaped pellets to provide excitement and offer a tantalizing taste to a bird's daily feeding. Each bite contains total nutrition so a bird can't selectively pick and choose its favorite ingredient

### DETAILED DESCRIPTION OF THE INVENTION

Protein is essential to all living creatures. For birds, it is important in the development of muscle tissue, bone, the immune system and blood components. Seed diets provide a large quantity of crude protein, sufficient to meet the general requirements of a diet. Proteins are made up of 22 amino acids, 10 of which are essential because that they cannot be manufactured by the body and must be consumed by the bird. Without a sufficient dietary supply of these essential amino acids, the necessary proteins cannot be produced by the bird. Too much protein in a pet bird's diet can lead to problems in the liver and kidney. The present bird food product contains egg, soybean meal and corn meal in addition to seeds and nuts in order to provide the protein necessary for muscle growth and strength in a pet bird.

Fats are an important source of energy for birds. Birds have a specific requirement for the fatty acids that are obtained from fats. Birds use fats for energy, absorption of fat soluble vitamins (A, D, E and K), overall growth and general feather condition. Seed diets provide ample amount of the essential fatty acids required by a bird. Excessive consumption of fatty food, such as sunflower seeds, can lead to obesity, with fatty deposits most noticeable in the chest of the bird. The instant bird food product provides complete balanced nutrition from a variety of nuts and seeds as a source of the essential fatty acids to promote healthy skin and colorful plumage in a pet bird.

Carbohydrates are the most important source of energy for birds; they are a quick source of energy and the only energy source that the bird's brain can use. Fats are the most efficient calorie source for birds as a result of easy metabolism. The instant extruded product contains fruits, vegetables, grains, beans and peas to provide carbohydrate amounts sufficient to meet the bird's nutritional needs.

Vitamins and minerals are essential to a healthy avian diet. There are two types of vitamins, fat soluble and water soluble. The fat soluble vitamins are stored in association with fat and can become toxic if consumed in large amounts. This can lead to calcification of the organs, especially the kidneys, which can lead to visceral gout and death. On the other hand, water soluble vitamins cannot be stored and thus must be provided in the bird's diet on a continuous basis. The minerals required for avian health are calcium, phosphorus, iron, magnesium, manganese and zinc. Calcium is most important for skeletal and feather health. Phosphorous must be consumed in proportion with the calcium provided in the diet and in combination with Vitamin D3 in order for the bird to obtain the nutritional advantage from ingested calcium. Applicant's product is fortified with important vitamins and minerals such as Vitamin E, B12, D3, K, riboflavin, potassium, thiamine, beta carotene, folic acid, calcium and potassium to supplement the balanced and complete avian diet.

Probiotics are added to the instant extruded diet in the form of active bacterial cultures. These probiotics aid in digestion and provide a healthy selection of intestinal bacteria.

Extrusion is a common method of manufacturing pet food. Extrusion is the cooking, shaping and cutting of raw ingredients into a specific pellet shape and size while effectively sterilizing the ingredients. The bird food ingredients are mixed into a homogenous dough and passed into and through the extruder barrel where it is subject to increasing levels of temperature, pressure and shear. As the material emerges from the extruder die, it is fully cooked and shaped and may typically be subdivided using a rotating knife assembly. In addition to destroying toxic microorganisms, extrusion causes rapid cooking of the starches, resulting in increased digestibility and palatability of the pet food. Avizon is produced as multi-colored, multi-shaped pellets to provide excitement to the bird and to offer a tantalizing taste to a bird's daily feeding.

Ingredients useful in the present invention include:

Fruits: fresh apples, fresh bananas, fresh oranges, dried papaya, dried coconut, dried pineapple, raisins

Vegetables: fresh broccoli, fresh spinach, fresh carrots, fresh sweet potatoes, green split peas, yellow split peas, trapper peas, flax seed, pinto beans, kidney beans, dried red peppers

Grains: corn, soybean meal, wheat, brown rice, corn gluten meal, oat groats, ground oats, vegetable oil, whole dried egg, dehydrated alfalfa meal, dried beet pulp, dried cane molasses, spirulina, wheat germ meal

Seeds/nuts: shelled sunflower seeds, shelled millet seeds, shelled whole peanuts, shelled almonds, safflower, shelled pumpkin seeds, filberts, shelled pistachios, shelled cashews, cantaloupe seed, pinenuts.

Vitamins/minerals: oyster shell, dicalcium phosphate, calcium carbonate, salt, choline chloride, Vitamin E supplement, Vitamin B12 supplement, riboflavin supplement, potassium sulfate, ferrous carbonate, zinc oxide, manganous oxide, menadione sodium bisulfite (vitamin K), niacin, calcium pantothenate, copper oxide, pyridoxine, cholecalciferol (source of vitamin D3), thiamine, mononitrate, folic acid, canthaxanthin, calcium lodate, cobalt carbonate, biotin, beta-carotene, sodium selenite

Probiotics: dried Bacillus coagulans (fermentation product), dried Bacillus licheniformis (fermentation product), dried Bacillus subtilis (fermentation product);

Vegetable Oil and whole dried eggs.

Misc.: brewers dried yeast, L-Lysine, DL-Methionine

Minimum of 16% crude protein, minimum 8% crude fat, maximum 5% crude fiber, maximum 12% moisture (highest levels in comparison to competition).

An exemplary non-limiting example of the present invention combines quality ingredients in a special, intensive cooking process to create a complete, fortified mix. The extruded product contains a unique slurry of wholesome, choice ingredients including fresh fruits, fresh vegetables, select seeds, crunchy nuts, wholesome grains and essential proteins. The product is fortified with important vitamins and minerals such as Vitamin E, B12, D3, K, Riboflavin, Potassium, Thiamine, Beta Carotene, Folic Acid, Calcium and Potassium and contains probiotics such as, for example, dried bacillus coagulans, dried bacillus licheniformis, dried bacillus subtillis for a healthy selection of intestinal bacteria. The multi-colored, multi-shaped extruded pellet provide excitement and offer a tantalizing taste to the bird's daily feeding. Each pellet contains total nutrition—so birds can't selectively pick and choose its favorite ingredient. The product an be contained in a resealable, stand-up barrier bag.

Notwithstanding that reference has been made to particular preferred embodiments, it will be further understood that the present invention is not to be construed as limited to such, rather than to the lawful scope of the appended claims.

1. A bird food product comprising extruded pellets made from a mixture containing grains, seeds and nuts and a slurry comprising fruits and vegetables.

2. The bird food product of claim 1, further comprising vitamins, minerals or probiotics.

3. The bird food product of claim 1, wherein the grains are at least one of corn, soybean meal, wheat, brown rice, corn gluten meal, oat groats, ground oats, dehydrated alfalfa meal, dried beet pulp, dried cane molasses, spirulina, wheat germ meal or mixtures thereof.

4. The bird food product of claim 1, wherein the seeds and nuts are at least one of sunflower seeds, millet seeds, whole peanuts, almonds, safflower, pumpkin seeds, filberts, pistachios, cashews, cantaloupe seed, flax seed pinenuts or mixtures thereof.

5. The bird food product of claim 1, wherein the fruits are at least one of apples, bananas, oranges, papaya, coconut, pineapple, raisins or mixtures thereof.

6. The bird food product of claim 1, wherein the vegetables are at least one of broccoli, spinach, carrots, sweet potatoes, green split peas, yellow split peas, trapper peas, pinto beans, kidney beans, red peppers or mixtures thereof.

7. The bird food product of claim 1, wherein the vitamins and minerals are at least one of oyster shell, dicalcium phosphate, calcium carbonate, salt, choline chloride, Vitamin E supplement, Vitamin B12 supplement, riboflavin supplement, potassium sulfate, ferrous carbonate, zinc oxide, manganous oxide, menadione sodium bisulfite, (vitamin K), niacin, calcium pantothenate, copper oxide, pyridoxine, cholecalciferol, thiamine, mononitrate, folic acid, canthaxanthin, calcium lodate, cobalt carbonate, biotin, beta-carotene, sodium selenite or mixtures thereof.

8. The bird food product of claim 1, wherein the probiotics comprise active bacterial cultures.

9. The bird food product of claim 7, wherein the probiotics are at least one of dried Bacillus coagulans, dried Bacillus licheniformis, dried Bacillus subtilis or mixtures thereof.

10. The bird food product of claim 1, further comprising at least one of Brewers dried yeast, L-lysine or DL-methionine.

11. The bird food product of claim 1, further comprising egg.

12. An extruded bird food product comprising the extrusion product of a mixture comprising fresh fruit, fresh vegetables, seeds, nuts, dried fruit, dried vegetables and grains.

13. The extruded bird food product of claim 10, further comprising vitamins or probiotics.

14. The bird food product of claim 1, having minimum 16% crude protein, maximum 5% crude fiber, minimum 8% crude fat and maximum 12% moisture.

15. The extruded bird food product of claim 10, having a mixture comprising a mixture comprising fresh fruit, fresh vegetables, seeds, nuts, dried fruit, dried vegetables and grains as in claim 12.

16. An extruded bird food product comprising pellets made from seeds, nuts, grains and essential proteins and having cooked therein fresh fruit and fresh vegetables.

17. An extruded bird food product according to claim 11, wherein the product is fortified with minerals, vitamins or probiotics.

18. The product according to claim 1, wherein the pellets are multi-colored and multi-shaped.

19. The extruded bird food product according to claim 10, wherein the product according to claim 14, wherein the pellets a mixture comprising fresh fruit, fresh vegetables, seeds, nuts, dried fruit, dried vegetables and grains as in claim 16.
